(19) United States
(12) Patent Application Publication
(10) Pub. No.: US 2023/0345888 A1
(43) Pub. Date: Nov. 2, 2023

(54) PLANT GROWTH MEDIA AND METHODS FOR USING THE SAME

(71) Applicant: Max Berryesa, Sebastopol, CA (US)

(72) Inventor: Max Berryesa, Sebastopol, CA (US)

(21) Appl. No.: 17/734,487

(22) Filed: May 2, 2022

(51) Int. Cl. A01G 24/46; A01G 24/35; A01G 24/22

(52) U.S. Cl. CPC A01G 24/46; A01G 24/35; A01G 24/22

(57) ABSTRACT

A plant growth medium, including: (a) a first segment; (b) a second segment; and (c) wherein the first segment comprises one or more nutrient(s) optimized for an initial stage of plant development, and wherein the second segment comprises one or more nutrient(s) optimized for a subsequent stage of plant development. The plant growth medium may optionally include additional segments for optimized plant growth and/or development.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A SEQUENCE LISTING

Not applicable.

### BACKGROUND OF THE INVENTION

### 1. Field of the Invention

The present invention relates in general to plant growth media, and, more particularly, to customized, nutrient segmented and self-contained plant growth media that only require the sun or artificial light for optimized plant growth and/or crop production from seed-to-harvest. The plant growth media of the present invention are suitable for both large scale (e.g., agricultural, horticultural, landscaping businesses, etcetera) and small scale (e.g., nurseries, gardens, backyard lawn and garden consumers, space station, etcetera) applications. The plant growth media of the present invention also enable individuals to easily plant crops and plants with all nutritional needs included, while making transport and storage easy for distributors and transportation companies.

### 2. Background Art

Plant growth media and associated methods for using the same have been known in the art for years and are the subject of a plurality of patents and publications, including: U.S. Pat. No. 7,823,328 entitled “Aeroponic Plant Growth System,” U.S. Pat. No. 6,332,287 entitled “Plant Cultivation Apparatus and Method,” U.S. Pat. No. 6,021,602 entitled “Modular Structure for Aeroponic Cultivations,” U.S. Pat. No. 5,979,111 entitled “Plant Growing System,” U.S. Pat. No. 4,255,898 entitled “Modular Plant Device,” U.S. Pat. No. 3,973,355 entitled “Self-Contained Hydrophilic Plant Growth Matrix and Method,” United States Patent Application Publication Number 2018/0000028 entitled “Multi-Media Structures Containing Growth Enhancement Additives,” United States Patent Application Publication Number 2008/0282610 entitled “Devices and Methods for Growing Plants,” Japanese Patent Number 2022-510271 entitled “Soilless Cultivation Medium for Indoor Agriculture,” and United Kingdom Patent Number 2532467 entitled “Vertical Soilless Growing System”—all of which are hereby incorporated herein by reference in their entirety including all references cited therein.

U.S. Pat. No. 7,823,328 appears to disclose an aeroponic plant growing system that includes a water reservoir and growing chambers for growing plants in an aeroponic environment. A pump, a water distribution manifold, and water lines are used to provide water and nutrients from the water reservoir to sprayers in the growing chambers where the water and nutrients are sprayed on the roots of plants growing therein. The water distribution manifold and water lines preferably are provided as closed loop systems, such that water is provided to all sprayers despite a blockage in the manifold or a water line. Non-absorbed water and nutrients are returned to the water reservoir from the growing chambers on water return lines via a filter that includes multiple types of filter media, including filter media that support the colonization of organisms that support plant growth.

U.S. Pat. No. 6,332,287 appears to disclose an apparatus and method for growing plants with controlled rates of nutrient and water input. The apparatus and method include the use of a reservoir container and a basket-style growing medium container having perforated side and bottom walls spaced inwardly from the walls of the reservoir container. The apparatus is closed by a top wall having openings through which plants can grow with their roots imbedded in a growing medium within the basket-style growing medium container. Water is provided in a reservoir below the bottom wall of the basket-style growing medium container which may have a mechanism for assisting the transfer of water from the reservoir into the growing medium. Pre-selected plant nutrients (e.g., N, K) are appropriately placed in the growing medium at the time of planting and are used over the course of time for plant growth.

U.S. Pat. No. 6,021,602 appears to disclose a modular structure for aeroponic cultivations that includes a plurality of prefabricated side panels which are meant to receive plants being cultivated and a plurality of prefabricated flat bases to which the side panels are joined by means of respective interlock couplings in order to form a structure which is substantially shaped like an inverted V and in which the side panels are mutually connected along an upper ridge line by respective ridge caps; a pumping unit and a spraying apparatus are also provided in order to feed an atomized nutrient solution inside the structure.

U.S. Pat. No. 5,979,111 appears to disclose a plurality of plant flats that are supported on a movable plant flat support rack positioned adjacent an irrigation trough for movement between an upper position and a lower position; idler rollers on the support rack engage inclined tracks on opposite sides of the irrigation trough so that horizontal movement of the support rack results in vertical movement of the support between an upper position in which the flats are above the upper surface of the trough liquid and a lower position in which the bottom of the flats is immersed in the liquid in the trough. A portable dive assembly is connected to the plant flat for support effecting horizontal movement of the rolls.

U.S. Pat. No. 4,255,898 appears to disclose a channel culture device for plant systems which comprises a plurality of longitudinal growing channels, for growing the primary plants, and service channels, which aid the growing channels. The channels alternate and fluids, water and air, pass laterally between the growing and service channels which enhance plant growth.

U.S. Pat. No. 3,973,355 appears to disclose methods of making a self-contained hydrophilic plant growth matrix having excellent water holding properties for germination of seeds, propagation of cuttings and growth of plants. The hydrophilic plant growth matrix is a dried, gelled plant growth particulate material mix, a cohesive plant mass which retains its shape and dimensional stability after rewetting. It may be formed in various shapes, such as pellets, plugs, cylinders, rods, blocks and the like. The gelled plant growth mix may be inserted in a plant matrix carrier or container which does not confine or impede root growth in any direction, such as an open cell foam, and preferably one which contains necessary nutrients for plant growth. The dried foam matrix has from about one-half of one to about five percent by weight, of a particulate, water-insoluble, water-swellable, cross-linked polymer dispersed throughout based on the dry weight of the plant growth particles. A gel of from ½ to 3% polymer in water is made and which is then mixed with and coats particles of growth material and dried, preferably to about 1% moisture. A number of examples is set forth and the drawings illustrate various physical embodiments of the invention.

United States Patent Application Publication Number 2018/0000028 appears to disclose multi-media structures with growth enhancement additives for multiple stages of growth of an organism such as a plant, fungus or bacteria, including the production of individual media structures and multi-media structures for multi-stage growth. Methods for the production of individual media structure and multi-media structures with growth enhancement additives. Methods for using multi-media structures to grow an organism through multiple stages of growth such as root production, vegetative growth and flowering are also provided.

United States Patent Application Publication Number 2008/0282610 appears to disclose a soilless garden that includes a chamber including a sealed lower portion for storing liquid nutrient solution, and an upper portion including a support structure; soilless growth medium supported by the support structure and adapted to support at least one plant having roots; a removable germination cap located above the soilless growth medium; a conduit having a first end located substantially adjacent to the soilless growth medium, and a second end opposite to the first end; and a pump in the chamber, including an input for receiving the liquid nutrient solution from the lower portion of the chamber, and an output to deliver liquid nutrient solution through the conduit into the soilless growth medium. The support structure includes an opening directed toward the lower portion of the chamber for the liquid nutrient solution to drip from the roots of the at least one plant into the lower portion of the chamber.

Japanese Patent Number 2022-510271 appears to disclose a soilless cultivation medium having a light reflecting surface and a light absorbing surface for indoor agriculture, and a method of using the medium for germinating seeds and growing plants. In some embodiments, the soilless cultivation medium is spliced with a connecting weaving yarn that connects the weaving yarn of the light-reflecting plant-supporting surface weaving fabric and the weaving yarn of the base bottom surface of the light-absorbing weaving fabric in the woven fabric. It can be a woven fabric made from two woven fabrics that can be. By using the soilless cultivation medium in the embodiment of the present disclosure, evaporation from the nutrient delivery system can be reduced and the work efficiency of environment-controlled agriculture can be improved.

United Kingdom Patent Number 2532467 appears to disclose a vertical soilless growing system. The system includes an elongate housing for a vertical hydroponic growing system, and a vertical hydroponic apparatus for plant growing using such a housing. A method of growing plants using such an apparatus is also disclosed.

While the above-identified patents and publications do appear to disclose various plant growth media, they remain non-desirous and/or problematic inasmuch as, among other things, none of the above-identified patents and publications appear to provide for customized, nutrient segmented and self-contained plant growth media that only require the sun for optimized plant growth and/or crop production from seed-to-harvest.

These and other objects of the present invention will become apparent in light of the present specification, claims, and drawings.

### SUMMARY OF THE INVENTION

The following presents a simplified summary in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

The present invention is directed to a plant growth medium, comprising, consisting essentially of, and/or consisting of: (a) a first segment; (b) a second segment; and (c) wherein the first segment comprises one or more nutrient(s) optimized for an initial stage of plant development, and wherein the second segment comprises one or more nutrient(s) optimized for a subsequent stage of plant development.

In a preferred embodiment of the present invention, the plant growth medium further comprises a third segment, wherein the third segment comprises one or more nutrient(s) optimized for a subsequent stage of plant development after development in the second segment.

In another preferred embodiment of the present invention, the plant growth medium further comprises a fourth segment, wherein the fourth segment comprises one or more nutrient(s) optimized for a subsequent stage of plant development after development in the third segment.

In yet another preferred embodiment of the present invention, the first segment and the second segment comprise a polar solvent, such as, but not limited to, water.

In a preferred implementation of the present invention, the first segment and the second segment comprise a gelling agent, such as, but not limited to, agar, gelatin, xanthan gum, hydroxypropyl methylcellulose, magnesium aluminum silicate, an acrylate copolymer, a crosslinked polyacrylic acid, a hydrophobically-modified polyacrylate crosspolymer, and/or polyacrylate crosspolymer-6.

In another preferred implementation of the present invention, the first segment and the second segment are self-standing.

In yet another preferred implementation of the present invention, the one or more nutrient(s) in the first segment are independently selected from the group consisting of Tappin' Roots natural all stages plant fertilizer, water soluble nitrogen, water soluble phosphorous, water soluble potassium, and combinations thereof, and the one or more nutrient(s) in the second segment are independently selected from the group consisting of Tappin' Roots natural all stages plant fertilizer, water soluble nitrogen, water soluble phosphorous, water soluble potassium, and combinations thereof.

The present invention is further directed to a plant growth medium, comprising, consisting essentially of, and/or consisting of: (a) a first segment; (b) a second segment; (c) a third segment; (d) wherein the first, second, and third segments comprise a self-standing, aqueous gelled medium; and (e) wherein the first segment comprises one or more nutrient(s) optimized for an initial stage of plant development, wherein the second segment comprises one or more nutrient(s) optimized for a first subsequent stage of plant development, and wherein the third segment comprises one or more nutrient(s) optimized for a second subsequent stage of plant development.

In a preferred embodiment of the present invention, the one or more nutrient(s) in the first segment comprise Tappin' Roots natural all stages plant fertilizer, the one or more nutrient(s) in the second segment are independently selected from the group consisting of water soluble nitrogen, water soluble phosphorous, water soluble potassium, and combinations thereof, and the one or more nutrient(s) in the third segment are independently selected from the group consisting of water soluble nitrogen, water soluble phosphorous, water soluble potassium, and combinations thereof.

The present invention is yet further directed to a plant growth medium, comprising, consisting essentially of, and/or consisting of: (a) a first segment; (b) a second segment; (c) a third segment; (d) a fourth segment; (e) wherein the first, second, third, and fourth segments comprise a self-standing, aqueous gelled medium; and (f) wherein the first segment comprises one or more nutrient(s) optimized for an initial stage of plant development, wherein the second segment comprises one or more nutrient(s) optimized for a first subsequent stage of plant development, wherein the third segment comprises one or more nutrient(s) optimized for a second subsequent stage of plant development, and wherein the fourth segment comprises one or more nutrient(s) optimized for a third subsequent stage of plant development.

The present invention is also directed to a method for using a plant growth medium, comprising, consisting essentially of, and/or consisting of the steps of: (a) providing a plant growth medium according to claim 16; (b) inserting one or more plant seeds in the first segment of the plant growth medium; and (c) exposing the plant growth medium having the inserted seed(s) to at least one of sun light and artificial light for a period of time.

### BRIEF DESCRIPTION OF THE DRAWINGS

Certain embodiments of the present invention are illustrated by the accompanying figures. It will be understood that the figures are not necessarily to scale and that details not necessary for an understanding of the invention or that render other details difficult to perceive may be omitted.

It will be further understood that the invention is not necessarily limited to the particular embodiments illustrated herein.

The invention will now be described with reference to the drawings wherein:

FIG. 1 of the drawings is a transparent perspective view of a two-chamber plant growth medium fabricated in accordance with the present invention;

FIG. 2 of the drawings is top view of a two-chamber plant growth medium fabricated in accordance with the present invention;

FIG. 3 of the drawings is bottom view of a two-chamber plant growth medium fabricated in accordance with the present invention;

FIG. 4 of the drawings is a transparent perspective view of a three-chamber plant growth medium fabricated in accordance with the present invention;

FIG. 5 of the drawings is top view of a three-chamber plant growth medium fabricated in accordance with the present invention;

FIG. 6 of the drawings is bottom view of a three-chamber plant growth medium fabricated in accordance with the present invention;

FIG. 7 of the drawings is a transparent perspective view of a four-chamber plant growth medium fabricated in accordance with the present invention;

FIG. 8 of the drawings is top view of a four-chamber plant growth medium fabricated in accordance with the present invention; and

FIG. 9 of the drawings is bottom view of a four-chamber plant growth medium fabricated in accordance with the present invention.

### DETAILED DESCRIPTION OF THE INVENTION

While this invention is susceptible of embodiment in many different forms, there is shown in the drawings and described herein in detail several specific embodiments with the understanding that the present disclosure is to be considered as an exemplification of the principles of the invention and is not intended to limit the invention to the embodiments illustrated.

It will be understood that like or analogous elements and/or components, referred to herein, may be identified throughout the drawings by like reference characters. In addition, it will be understood that the drawings are merely schematic representations of one or more embodiments of the invention, and some of the components may have been distorted from their actual scale for purposes of pictorial clarity.

The plant growth media of the present invention are preferably customized, nutrient segmented and self-contained plant growth media that only require the sun for optimized plant growth and/or crop production from seed-to-harvest.

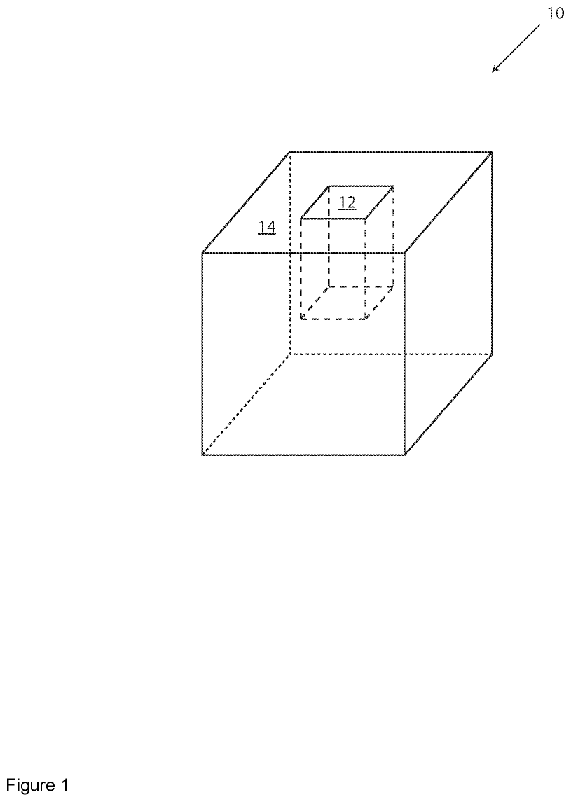

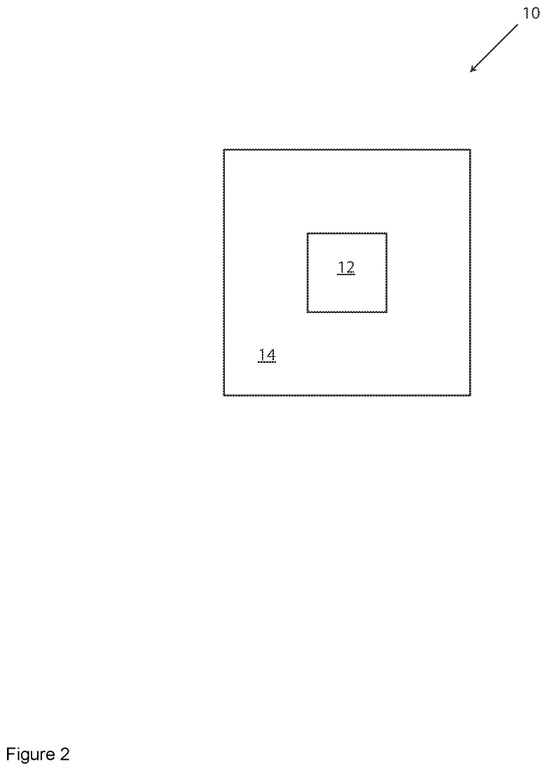

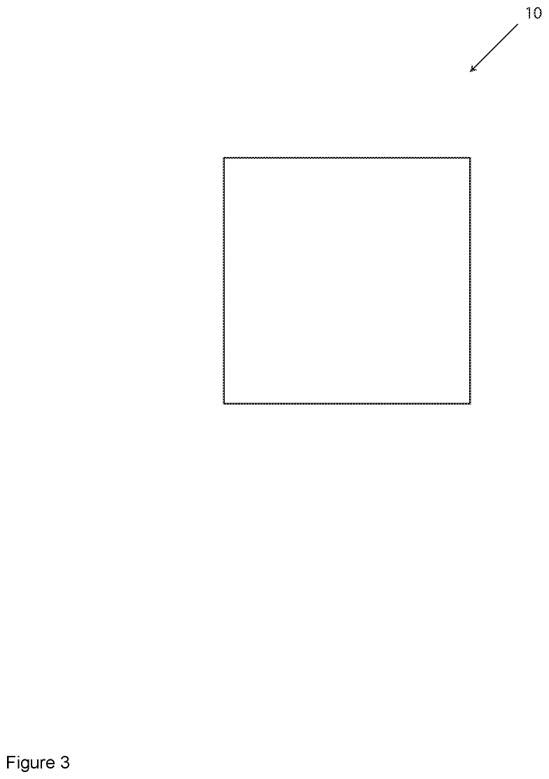

Referring now to the drawings, and to FIGS. 1-3 in particular, in a first embodiment, plant growth medium 10 generally comprises first segment 12 (e.g., chamber, section, compartment), and second segment 14. Preferably, first segment 12 comprises one or more nutrient(s) optimized for an initial stage of plant development, and second segment 14 comprises one or more nutrient(s) optimized for a subsequent stage of plant development.

In a preferred embodiment of the present invention, first segment 12 and second segment 14 comprise a solvent, such as water, distilled water, reverse osmosis water, tap water, well water, demineralized water, softened water, mineral water—just to name a few. It will be understood that other solvents or co-solvents that are compatible with plant and/or crop growth are likewise contemplated for use.

In another preferred embodiment of the present invention, first segment 12 and/or second segment 14 comprise a gelling agent. Suitable examples include, but are not limited to, agar, gelatin, xanthan gum, hydroxypropyl methylcellulose, magnesium aluminum silicate, an acrylate copolymer, a crosslinked polyacrylic acid, a hydrophobically-modified polyacrylate crosspolymer, and/or polyacrylate crosspolymer-6.

Preferably, the gelled segments result in the entire plant growth medium being self-standing.

In a preferred implementation of the present invention, the one or more nutrient(s) in first segment 12 are independently selected from the group consisting of Tappin' Roots natural all stages plant fertilizer (See U.S. Pat. No. 9,067,840 Entitled Organic Plant Nutrient which is hereby incorporated herein by reference in its entirety including all references cited therein), an organic plant nutrient salicylic acid and kelp, any type of hormone, a light nutrient, a plant-based regulator approved for plant growth, water soluble nitrogen, water soluble phosphorous, water soluble potassium, and combinations thereof, and the one or more nutrient(s) in second segment 14 are independently selected from the group consisting of Tappin' Roots natural all stages plant fertilizer, water soluble nitrogen (e.g., natural urea, synthetic organic urea, ammonium nitrate, ammonium sulfate, potassium nitrate, calcium nitrate, and mono-di-ammonium phosphate, selocitic acid, phidohormones, etcetera), water soluble phosphorous (e.g., bat guana, bone meal, rock phosphate, etcetera), water soluble potassium (e.g., greensand, kelp meal, hardwood ashes, etcetera), and combinations thereof. Tappin' Roots natural all stages plant fertilizer is commercially available from Tappin' Roots, LLC (Graton, California). Natural and synthetic nitrogen, phosphorous, and potassium are available from any one of a number of conventional vendors.

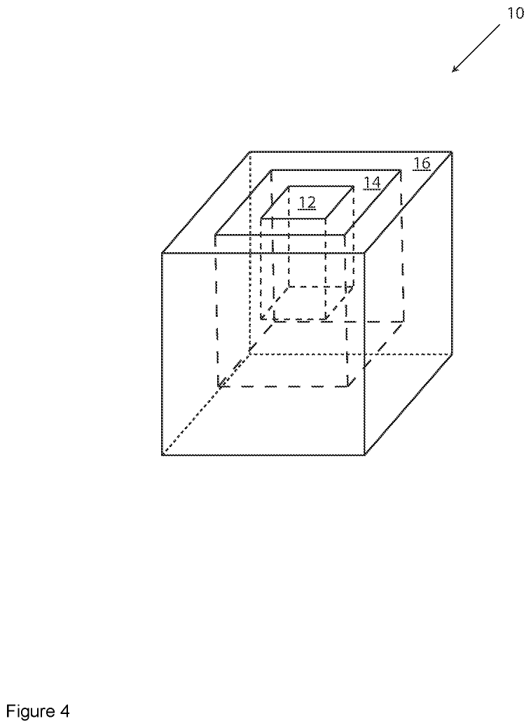

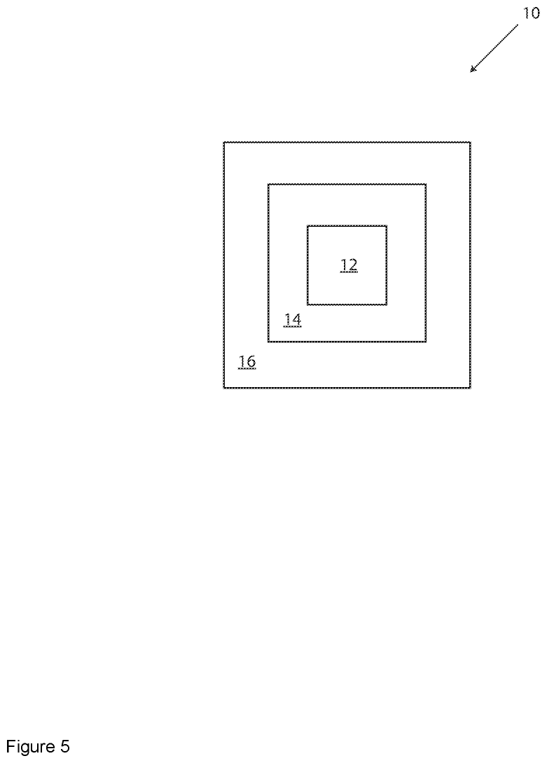

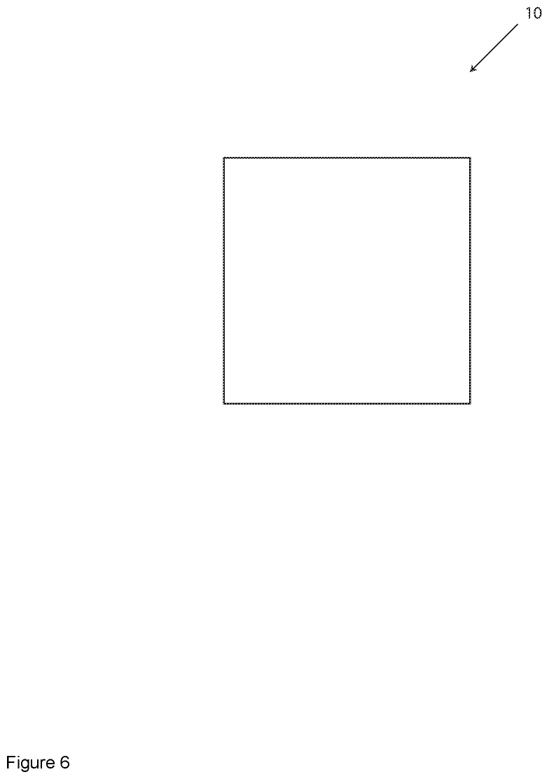

Referring now to the drawings, and to FIGS. 4-6 in particular, in a second embodiment, plant growth medium 10 generally comprises first segment 12 (e.g., chamber, section, compartment), second segment 14, and third segment 16. Preferably, the first, second, and third segments comprise a self-standing, aqueous gelled medium. In addition, first segment 12 preferably comprises one or more nutrient(s) optimized for an initial stage of plant development, second segment 14 preferably comprises one or more nutrient(s) optimized for a first subsequent stage of plant development, and third segment 16 preferably comprises one or more nutrient(s) optimized for a second subsequent stage of plant development.

In one embodiment, the one or more nutrient(s) in first segment 12 comprise Tappin' Roots natural all stages plant fertilizer, the one or more nutrient(s) in second segment 14 are independently selected from the group consisting of water soluble nitrogen, water soluble phosphorous, water soluble potassium, and combinations thereof, and the one or more nutrient(s) in third segment 16 are independently selected from the group consisting of water soluble nitrogen, water soluble phosphorous, water soluble potassium, and combinations thereof.

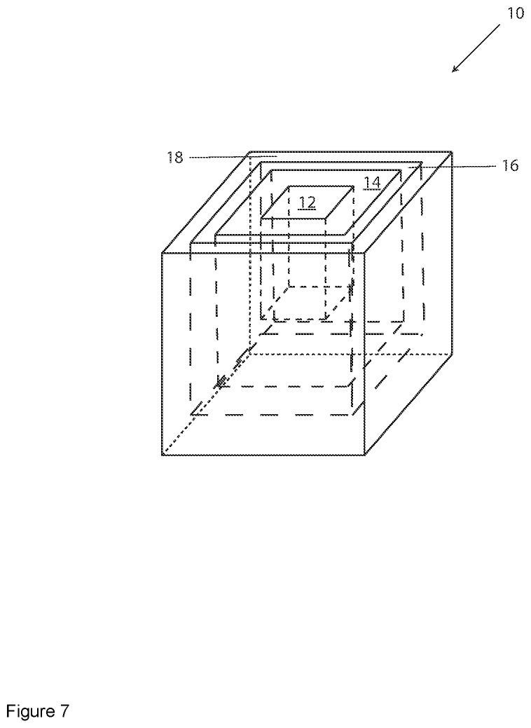

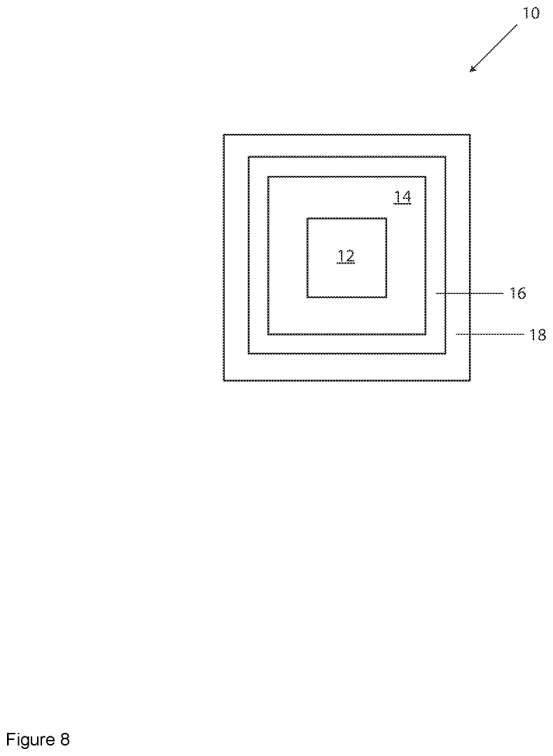

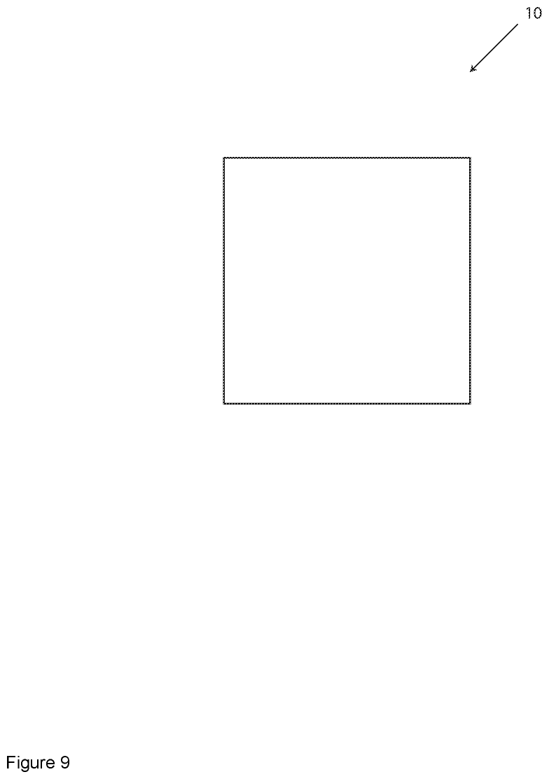

Referring now to the drawings, and to FIGS. 7-9 in particular, in a third embodiment, plant growth medium 10 generally comprises first segment 12 (e.g., chamber, section, compartment), second segment 14, third segment 16, and fourth segment 18. Preferably, the first, second, third, and fourth segments comprise a self-standing, aqueous gelled medium. Moreover, first segment 12 preferably comprises one or more nutrient(s) optimized for an initial stage of plant development, second segment 14 preferably comprises one or more nutrient(s) optimized for a first subsequent stage of plant development, third segment 16 preferably comprises one or more nutrient(s) optimized for a second subsequent stage of plant development, and fourth segment 18 comprises one or more nutrient(s) optimized for a third subsequent stage of plant development.

In another preferred embodiment of the present invention, plant growth medium 10 may comprise the general geometry of a cube, a cuboid, a tetrahedron, a pyramid, a square pyramid, a hexagonal pyramid, a prism, a triangular prism, a pentagonal prism, a hexagonal prism, an octahedron, a dodecahedron, an icosahedron, a cylinder, a cone, a sphere, an ellipsoid, and/or any polygonal shape.

In will be understood that plant growth medium 10 is suitable for growing any organism including plants, algae and/or fungi.

It will be further understood that plant growth medium 10 may comprise any one of a number of segments (e.g., 2, 3, 4, 5, 6, 7, 8, 9, 10, 15, 50, 100, etcetera).

Additionally, one or more components of plant growth medium 10 may also be optionally oxygenated with pure oxygen or diluted oxygen, aerated, dehydrated (and subsequently rehydrated to save space during storage and/or transportation), and/or freeze dried using any one of a number of conventional techniques. Moreover, any given layer of the medium can be replaced with a dry and/or compressed solid with a nutrient value (e.g., a layer made of soil, benign powder with a nutrient value). This embodiment provides for a lighter medium, and the water component of the gelatin preferably remains in the cube. Furthermore, pesticides and/or insect repellants can be added to the outer layer to protect the growth media from harmful insects. Alternatively, the outer layer can comprise a protective coating, such as a polymer or vinyl-type shell. The plant growth media products of the present invention may be fabricated as disclosed herein and/or using different methods including pressure or injection molding and the use of a 3-D printer.

In one embodiment of the present invention, the space between segments may filled with one or more filler materials, including, but not limited to, cellulose, shredded cellulose, popped perlite, expanded perlite, a siliceous volcanic glass, expanded aluminum silicate, vermiculite, and/or lignocellulosic fiber.

In operation, a user prepares the desired number of chambers or segments using a conventional mold with separators or partitions. The separators may be made of metal, plastic, glass and/or any substrate that is substantially water impermeable. The segments are loaded or charged with desired components (e.g., water, gel, nutrients, etcetera) and allowed to gel. Once gelled, the partitions are removed leaving a self-standing gelled plant growth medium.

Provided below are non-limiting examples of plant growth media.

### Example I (Cube 1-4 Chambers)

1. The Core (First Segment)
   a. 15 g gelatin powder and ½ cup water were mixed.
   b. 0.5 cup Tappin Roots Hormone was added.
   c. Mix gelatin and Tappin Roots in basin or reservoir for 3 minutes at 120 degrees (alternatively can be done at cooler temperatures—mixed for longer time period); Inject the gelatin into core using funnel or any other similar object.
   d. Let the mixture sit in the mold for 4-5 minutes until it becomes solidified.
2. Nitrogen Chamber (Second Segment)
   a. 30 grams gelatin powder was mixed with 3¼ cups water.
   b. 5 grams of water soluble Nitrogen was added.
   c. Mix gelatin and Nitrogen in basin or reservoir for 5 minutes at 120 degrees (alternatively can be done at cooler temperatures—mixed for longer time period); Inject the gelatin into core using funnel or any other similar object.
   d. Let the mixture sit in the mold for 4-5 minutes until it becomes solidified.
3. Phosphorous Chamber (Third Segment)
   a. 45 grams of gelatin powder was mixed with 6½ cups water.
   b. 10 grams of water soluble phosphorous was added.
   c. Mix gelatin and Phosphorous in basin or reservoir for 7 minutes at 120 degrees (alternatively can be done at cooler temperatures—mixed for longer time period); Inject the gelatin into core using funnel or any other similar object.
   d. Let the mixture sit in the mold for 4-5 minutes until it becomes solidified.
4. Potassium Chamber (Fourth Segment)
   a. 55 grams of gelatin was mixed with 7 cups of water.
   b. 15 grams of a water soluble potassium was added.
   c. Mix gelatin and water soluble potassium in basin or reservoir for 9 minutes at 120 degrees (alternatively can be done at cooler temperatures—mixed for longer time period); Inject the gelatin into core using funnel or any other similar object.
   d. Let the mixture sit in the mold for 4-5 minutes until it becomes solidified.
5. On bottom of cube and top of the cube pour 10 grams of gelatin mixed with 6½ cups of water; pour a thin layer on bottom and layer on each side to seal all the sides.
6. Add aeration granular that will create micro holes into the cube.
7. Others:
   a. Take 0.5 of each measurement—cube #1

### Example II (Cube 2-4 Chambers)

1. The Core (First Segment)
   a. 15 g gelatin powder and ½ cup water were mixed.
   b. 0.25 cup Tappin Roots Hormone was added.
   c. Mix gelatin and Tappin Roots in basin or reservoir for 3 minutes at 120 degrees (alternatively can be done at cooler temperatures—mixed for longer period); Inject the gelatin into core using funnel or any other similar object, or pressure tube connected to big batch reservoir.
   d. Let the mixture sit in the mold for 4-5 minutes until it becomes solidified.
2. Nitrogen Chamber (Second Segment)
   a. 25 grams gelatin powder was mixed with 3¼ cup water.
   b. 10 grams of water soluble Nitrogen was added.
   c. Mix gelatin and Nitrogen in basin or reservoir for 5 minutes at 120 degrees (alternatively can be done at cooler temperatures—mixed for longer period); Inject the gelatin into core using funnel or any other similar object. or pressure tube connected to big batch reservoir or 3d printer.
   d. Let the mixture sit in the LC for 4-5 minutes until it becomes solidified.
3. Phosphorous Chamber (Third Segment)
   a. 50 grams of gelatin powder was mixed with 6½ cup water.
   b. 5 grams of water soluble phosphorous was added.
   c. Mix gelatin and Phosphorous in basin or reservoir for 7 minutes at 120 degrees (alternatively can be done at cooler temperatures—mixed for longer period); Inject the gelatin into core using funnel or any other similar object.
   d. Let the mixture sit in the mold for 4-5 minutes until it becomes solidified.
4. Potassium Chamber (Fourth Segment)
   a. 55 grams of gelatin was mixed with 7 cups of water.
   b. 20 grams of a water soluble potassium was added.
   c. Mix gelatin and water soluble potassium in basin or reservoir for 9 minutes at 120 degrees (alternatively can be done at cooler temperatures—mixed for longer period); Inject the interior gelatin to the core using funnel or any other similar object or pressure container or tube connected to big batch reservoir 3D printer.
   e. Let the mixture sit in the mold for 4-5 minutes until it becomes solidified.
5. On bottom of cube and top of the cube pour 10 grams of gelatin mixed with 6½ cups of water; pour a thin layer on bottom and layer on each side to seal all the sides.
6. Add aeration granular that will create micro holes into the cube.
7. Others:
   a. Take 0.5 of each measurement—cube #1

### Example III (Cube 3-3 Chambers)

1. The Core (First Segment)
   a. 15 g gelatin powder and 4.2 cup water were mixed.
   b. 0.25 cup Tappin Roots Hormone was added.
   c. 2 grams of water soluble Nitrogen was added.
   d. Mix gelatin and Tappin Roots in basin or reservoir for 3 minutes at 120 degrees (alternatively can be done at cooler temperatures—mixed for longer period); Inject the into gelatin core using funnel or any other similar object, or pressure tube connected to big batch reservoir.
   e. Let the mixture sit in the mold for 4-5 minutes until it becomes solidified.
2. Phosphorous Chamber (Second Segment)
   a. 35 grams of gelatin powder was mixed with 6½ cup water.
   b. 5 grams of water soluble phosphorous was added.
   c. Mix gelatin and Phosphorous in basin or reservoir for 7 minutes at 120 degrees (alternatively can be done at cooler temperatures—mixed for longer period); Inject the gelatin into core using funnel or any other similar object.
   d. Let the mixture sit in the mold for 4-5 minutes until it becomes solidified.
3. Potassium Chamber (Third Segment)
   a. 60 grams of gelatin was mixed with 7 cups of water.
   b. 10 grams of a water soluble potassium was added.
   c. Mix gelatin and water soluble potassium in basin or reservoir for 9 minutes at 120 degrees (alternatively can be done at cooler temperatures—mixed for longer period); Inject the gelatin into core using funnel or any other similar object or pressure tube connected to big batch reservoir or 3D printer.
   e. Let the mixture sit in the mold for 4-5 minutes until it becomes solidified.
4. On bottom of cube and top of the cube pour 10 grams of gelatin mixed with 6½ cups of water; pour a thin layer on bottom and layer on each side to seal all the sides.
5. Add aerate granular that will create micro holes into the cube.
6. Others:
   a. Take 0.5 of each measurement—cube #1

### Example IV (Cube 4-4 Chambers)

1. The Core (First Segment)
   a. 45 g gelatin powder and ½ cup water were mixed.
   b. 1 cup Tappin Roots Hormone was added.
   c. 5 g water soluble Nitrogen was added.
   d. Mix gelatin and Tappin Roots and Nitrogen in basin or reservoir for 3 minutes at 120 degrees (alternatively can be done at cooler temperatures—mixed for longer time period); Inject the gelatin into core using funnel or any other similar object.
   e. Let the mixture sit in the mold for 4-5 minutes until it becomes solidified.
2. Phosphorous Chamber (Second Segment)
   a. 45 grams of gelatin powder was mixed with 6 cups water.
   b. 10 grams of water soluble phosphorous was added.
   c. Add 0.5 cup Tappin Roots hormone was added.
   d. Mix gelatin and Phosphorous in basin or reservoir for 7 minutes at 120 degrees (alternatively can be done at cooler temperatures—mixed for longer time period); Inject the gelatin into core using funnel or any other similar object.
   e. Let the mixture sit in the mold for 4-5 minutes until it becomes solidified.
3. Potassium Chamber (Third Segment)
   a. 55 grams of gelatin was mixed with 6½ cups of water.
   b. 15 grams of a water soluble potassium was added.
   c. Add 0.5 cup Tappin Roots hormone was added.
   d. Mix gelatin and water soluble potassium in basin or reservoir for 9 minutes at 120 degrees (alternatively can be done at cooler temperatures—mixed for longer time period); Inject the gelatin into core using funnel or any other similar object.
   e. Let the mixture sit in the mold for 4-5 minutes until it becomes solidified.
4. On bottom of cube and top of the cube pour 10 grams of gelatin mixed with 6½ cups of water; pour a thin layer on bottom and layer on each side to seal all the sides.
5. Add aeration granular that will create micro holes into the cube.
6. Others:
   a. Take 0.5 of each measurement—cube #1

### Example V (Cube 5-3 Chambers)

1. The Core (First Segment)
   a. 45 g gelatin powder and ½ cup water were mixed.
   b. 1 cup Tappin Roots Hormone was added.
   c. 2 g water soluble Nitrogen was added.
   d. 3.5 grams of water soluble phosphorous was added.
   e. 1 grams of a water soluble potassium was added.
   f. Mix gelatin and Tappin Roots and Nitrogen in basin or reservoir for 3 minutes at 120 degrees (alternatively can be done at cooler temperatures—mixed for longer time period); Inject the gelatin into core using funnel or any other similar object.
   g. Let the mixture sit in the mold for 4-5 minutes until it becomes solidified.
2. Phosphorous Chamber (Second Segment)
   a. 2 g water soluble Nitrogen was added.
   b. 3 g water soluble Phosphorous was added.
   c. 3 g of water soluble Potassium was added.
   d. mixed with 6 cups water.
   e. Mix gelatin and substances above in basin or reservoir for 7 minutes at 120 degrees (alternatively can be done at cooler temperatures—mixed for longer time period); Inject the gelatin into core using funnel or any other similar object.
   f. Let the mixture sit in the mold for 4-5 minutes until it becomes solidified.
3. Potassium Chamber (Third Segment)
   a. 55 grams of gelatin was mixed with 6½ cups of water.
   b. Add 0.5 cup Tappin Roots hormone was added.
   c. Mix gelatin and water soluble potassium in basin or reservoir for 9 minutes at 120 degrees (alternatively can be done at cooler temperatures—mixed for longer time period); Inject the gelatin into core using funnel or any other similar object.
   d. Let the mixture sit in the mold for 4-5 minutes until it becomes solidified.
4. On bottom of cube and top of the cube pour 10 grams of gelatin mixed with 6½ cups of water; pour a thin layer on bottom and layer on each side to seal all the sides.
5. Add aeration granular that will create micro holes into the cube.
6. Others:
   a. Take 0.5 of each measurement—cube #1

The foregoing description merely explains and illustrates the invention and the invention is not limited thereto except insofar as the appended claims are so limited, as those skilled in the art who have the disclosure before them will be able to make modifications without departing from the scope of the invention.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etcetera shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etcetera. As a non-limiting example, each range discussed herein can be readily broken down into a lower third, middle third and upper third, etcetera. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

1. A plant growth medium, comprising:
a first segment;
a second segment, wherein the second segment is positioned around and below the first segment; and
wherein the first segment comprises kelp and salicylic acid obtained from organic plant nutrient optimized for an initial stage of plant development, and wherein the second segment comprises one or more nutrient(s) optimized for a subsequent stage of plant development.

2. The plant growth medium according to claim 1, further comprising a third segment, wherein the third segment comprises one or more nutrient(s) optimized for a subsequent stage of plant development after development in the second segment.

3. The plant growth medium according to claim 2, further comprising a fourth segment, wherein the fourth segment comprises one or more nutrient(s) optimized for a subsequent stage of plant development after development in the third segment.

4. The plant growth medium according to claim 1, wherein the first segment and the second segment comprise a polar solvent.

5. The plant growth medium according to claim 4, wherein the polar solvent comprises water.

6. The plant growth medium according to claim 5, wherein the first segment and the second segment comprise a gelling agent.

7. The plant growth medium according to claim 6, wherein the first and second segments comprise a gelling agent independently selected from the group consisting of agar, gelatin, xanthan gum, hydroxypropyl methylcellulose, magnesium aluminum silicate, an acrylate copolymer, a crosslinked polyacrylic acid, a hydrophobically-modified polyacrylate crosspolymer, polyacrylate crosspolymer-6, and combinations thereof.

8. The plant growth medium according to claim 7, wherein the first segment and the second segment are self-standing.

9. (canceled)

10. The plant growth medium according to claim 1, wherein the one or more nutrient(s) in the second segment are independently selected from the group consisting of water soluble nitrogen, water soluble phosphorus, water soluble potassium, and combinations thereof.

11. (canceled)

12. A plant growth medium, comprising:
a first segment;
a second segment;
a third segment;
wherein the third segment is positioned around and below the second segment and the second segment is positioned around and below the first segment;
wherein the first, second, and third segments comprise a self-standing, aqueous gelled medium; and
wherein the first segment comprises kelp and salicylic acid obtained from organic plant nutrient optimized for an initial stage of plant development, wherein the second segment comprises one or more nutrient(s) optimized for a first subsequent stage of plant development, and wherein the third segment comprises one or more nutrient(s) optimized for a second subsequent stage of plant development.

13. (canceled)

14. The plant growth medium according to claim 12, wherein the one or more nutrient(s) in the second segment are independently selected from the group consisting of water soluble nitrogen, water soluble phosphorus, water soluble potassium, and combinations thereof.

15. The plant growth medium according to claim 12, wherein the one or more nutrient(s) in the third segment are independently selected from the group consisting of water soluble nitrogen, water soluble phosphorus, water soluble potassium, and combinations thereof.

16. A plant growth medium, comprising:
a first segment;
a second segment;
a third segment;
a fourth segment;
wherein the fourth segment is positioned around and below the third segment, the third segment is positioned around and below the second segment, and the second segment is positioned around and below the first segment;
wherein the first, second, third, and fourth segments comprise a self-standing, aqueous gelled medium; and
wherein the first segment comprises kelp and salicylic acid obtained from organic plant nutrient optimized for an initial stage of plant development, wherein the second segment comprises one or more nutrient(s) optimized for a first subsequent stage of plant development, wherein the third segment comprises one or more nutrient(s) optimized for a second subsequent stage of plant development, and wherein the fourth segment comprises one or more nutrient(s) optimized for a third subsequent stage of plant development.

17. A method for using a plant growth medium, comprising the steps of:
providing a plant growth medium according to claim 16;
inserting one or more plant seeds in the first segment of the plant growth medium; and
exposing the plant growth medium having the inserted seed(s) to sun light and/or artificial light for a period of time.
